(19) United States
(12) Patent Application Publication
(10) Pub. No.: US 2017/0046636 A1
(43) Pub. Date: Feb. 16, 2017

(54) METHOD AND SYSTEM FOR PROVIDING TRAVEL SUPPORT SERVICES

(71) Applicant: MASTERCARD INTERNATIONAL INCORPORATED, Purchase, NY (US)

(72) Inventors: Henry Y. Neale, Acton, MA (US); Justin X. Howe, San Francisco, CA (US); Randall K. Shuken, Westport, CT (US)

(21) Appl. No.: 14/826,853

(22) Filed: Aug. 14, 2015

(51) Int. Cl. G06Q 10/02; G06Q 50/14; G06Q 30/00

(52) U.S. Cl. CPC G06Q 10/025; G06Q 30/016; G06Q 50/14

(57) ABSTRACT

A method and a system are provided for offering travel support services. In particular, the method includes retrieving from one or more databases a first set of information comprising payment card transaction information of one or more entities including addenda information; retrieving from one or more databases a second set of information including vendor information; and retrieving from one or more databases a third set of information comprising external information. The method further includes analyzing the first set of information, the second set of information, and the third set of information to identify one or more associations between the payment card transaction information, the vendor information and the external information; identifying planned travel information for the one or more entities based on the one or more associations; and in response to an event indicating a change of current travel information, transmitting a message to the one or more entities offering a possible change of the planned travel information.

### BACKGROUND OF THE DISCLOSURE

1. Field of the Disclosure

The present disclosure relates to a method and a system for providing travel support services. In particular, the present disclosure relates to a method and a system that can dynamically make needed changes (e.g., rebooking) in travel arrangements (e.g., travel itineraries) in the event that planned travel arrangements change for whatever reason.

2. Description of the Related Art

Procurement and tracking of travel and related services can be substantially improved by using modern technologies such as the Internet, mobile technology, GPS and other information technologies. Travelers require the ability to search for, exchange information about, reserve, rebook, pay for, document and use other functionalities related to goods, services, information or other travel needs, especially when an event causes disruption of planned travel itineraries and new travel itineraries are required for the travelers.

For example, travelers may purchase an international flight to some city in the U.S., and as part of their journey be required to transfer flights in the U.S. (e.g., at Newark, N.J.) to get to their final destination. If the international departure flight is delayed for some reason, then sometimes passengers miss the transfer flight at no fault of their own, and are forced to stay in a hotel overnight or transfer to a flight with a much later arrival time to their destination. This is very inconvenient and results in customer dissatisfaction. In business scenarios, this type of problem has the potential to massively disrupt revenues and increase overall costs for all parties involved.

The events causing disruption of planned travel itineraries experienced by travelers can equally apply to all areas of travel and related goods and services. These may include, for example, aircraft, rental vehicles, lodging, trains, boats or cruises, entertainment (including movies or shows), meals, incidentals, or other goods or services. As such, travelers seek the ability to dynamically make needed changes in travel itineraries and rebook in the event that planned itineraries change so as to minimize any inconvenience or travel delay.

To date, many post-booking consumer needs have not been adequately met. For example, following the booking of travel arrangements, there may be a desire for the provision or receipt of alerts and updates, the provision or receipt of advice, as well as the providing and receiving of rebooking support. These features have not been sufficiently supported in the prior art.

Accordingly, a need exists for a system and a method that can dynamically make needed changes in travel itineraries and rebook in the event that planned itineraries change for whatever reason. This will allow travelers to minimize overall travel delay and inconvenience in the event of a disruption of their planned travel itineraries. This will also allow travel vendors (e.g., airlines) to address a pain point that will positively impact customer satisfaction.

### SUMMARY OF THE DISCLOSURE

The present disclosure relates to a method and a system for providing travel support services. In particular, the present disclosure relates to a method and a system that dynamically makes needed changes (e.g., rebooking) in travel arrangements (e.g., travel itineraries) in the event that planned travel arrangements change for whatever reason.

The present disclosure provides a computer-implemented method for travel support services. The method involves retrieving from one or more first databases a first set of information comprising payment card transaction information of one or more entities including addenda information; retrieving from one or more second databases a second set of information comprising vendor information of one or more vendors; and retrieving from one or more third databases a third set of information comprising external information. The method further involves analyzing the first set of information, the second set of information, and the third set of information to identify one or more associations between the payment card transaction information, the vendor information and the external information; identifying planned travel information for the one or more entities based on the one or more associations; and, in response to an event indicating a change of current travel information, transmitting a message to the one or more entities offering a possible change of the planned travel information.

In an embodiment, the method further involves determining a service that is available in which the service helps reduce a negative consequence associated with the event, and generating an entity-selectable option offering to provide the service. The service can include, for example, implementing or facilitating the booking of new travel arrangements, implementing or facilitating the booking of a new airline ticket, implementing or facilitating the booking of new hotel reservations, implementing or facilitating a cancellation of existing travel arrangements, and/or implementing or facilitating a modification of existing travel arrangements.

The present disclosure also provides a system that includes one or more first databases configured to store a first set of information comprising payment card transaction information of one or more entities including addenda information; one or more second databases configured to store a second set of information comprising vendor information of one or more vendors; and one or more third databases configured to store a third set of information comprising external information. The system further includes a processor configured to: analyze the first set of information, the second set of information, and the third set of information to identify one or more associations between the payment card transaction information, the vendor information and the external information; identify planned travel information for the one or more entities based on the one or more associations; and, in response to an event indicating a change of current travel information, transmit a message to the one or more entities offering a possible change of the planned travel information.

In an embodiment, the processor is further configured to: determine a service that is available in which the service helps reduce a negative consequence associated with the event, and generate an entity-selectable option offering to provide the service. The service can include, for example, implementing or facilitating the booking of new travel arrangements, implementing or facilitating the booking of a new airline ticket, implementing or facilitating the booking of new hotel reservations, implementing or facilitating a cancellation of existing travel arrangements, or implementing or facilitating a modification of existing travel arrangements.

### BRIEF DESCRIPTION OF THE DRAWINGS

FIG. 1 is a diagram of a four party payment card system.

FIG. 2 illustrates a data warehouse shown in FIG. 1 that is a central repository of data that is created by storing certain transaction data from transactions occurring in four party payment card system of FIG. 1.

FIG. 3 shows illustrative information types used in the systems and the methods of the present disclosure.

FIG. 4 illustrates an exemplary dataset for the storing, reviewing, and/or analyzing of information used in the systems and the methods of the present disclosure.

FIG. 5 is a block diagram illustrating a method for providing travel support services to one or more entities, in accordance with exemplary embodiments of the present disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the disclosure are shown. Indeed, the present disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

In an embodiment, the service provided by this disclosure enables entities to identify situations in which airline passengers are at risk of missing a transfer or connecting flight as the result of their previous flight being delayed. The service will leverage passenger itinerary data to reschedule those airline passengers to the “Most Convenient Alternative” which would ideally be another flight from a partner airline that has the same or a very similar arrival time as the missed-transfer flight. In cases where such a solution is possible, the service will swap a passenger booked for a later flight who is already in the airport and ready to leave, onto the seat of an earlier flight that is booked for someone whose origin departure flight was late and who would miss the transfer flight as a result. This type of seamless switch benefits all entities involved.

In the above embodiment, the airline passengers overall trip delay is minimized. This is convenient for airline passengers because the aforementioned types of delays which cause passengers to miss their transfer flights are often completely outside the passengers' realm of control. Missing a transfer flight is inconvenient and may frustrate passengers involved because they often have to stay overnight at a nearby hotel and wait for a flight with a much later arrival time to their intended destination. In business scenarios, this can be a huge cost to all parties involved. This service will also allow airlines to address a pain point that will positively impact customer satisfaction.

Companies such as FlightAware.com make real-time flight information available for purchase via APIs, and entities can access scheduled flight numbers using global distribution systems (GDS), billing and settlement plan (BSP), or addenda data sources. In this embodiment, the service can expand even so far as booking transportation and hotels for anyone whose flight has been cancelled. Passengers can be notified via short message service (SMS), rather than standing at a ticket counter with all of their other passengers and waiting to be told when their next flight is scheduled.

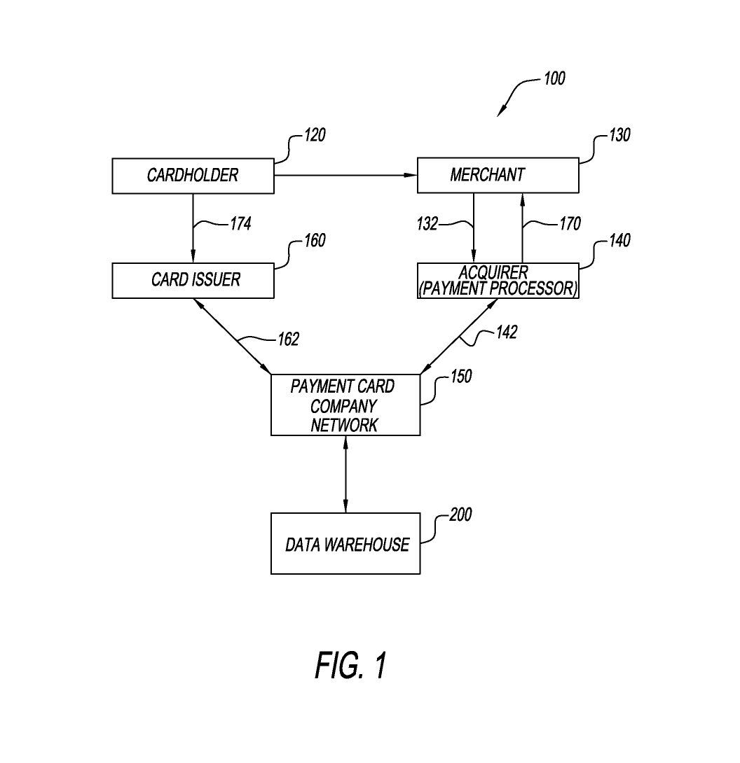

Referring to the drawings and, in particular, FIG. 1, there is shown a four party payment (credit, debit or other) card system generally represented by reference numeral 100. In card system 100, cardholder 120 submits the payment card to the vendor 130. The vendor's point of sale (POS) device communicates 132 with his acquiring bank or acquirer 140, which acts as a payment processor. The acquirer 140 initiates, at 142, the transaction on the payment card company network 150. The payment card company network 150 (that includes a financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the vendor 130. Thereafter, seconds later, if the transaction is approved, the cardholder completes the purchase and receives a receipt.

The account of the vendor 130 is credited, via 170, by the acquirer 140. The card issuer 160 pays the acquirer 140. Eventually, the cardholder 120 pays, via 174, the card issuer 160.

Data warehouse 200 is a global database used by payment card company network 150 for reporting and data analysis. According to one embodiment, data warehouse 200 is a central repository of data, having one or more databases, that is created by storing certain transaction data from transactions occurring within four party payment card system 100. According to another embodiment, data warehouse 200 stores, for example, the date, time, amount, location, vendor code, vendor category (e.g., airlines, lodging, rental cars, etc.) and vendor geolocation for every transaction occurring within payment card network 150. In addition to payment card transaction information and vendor information, data warehouse 200 can also store external information such as traveler information (e.g., live flight tracking information at FlightAware.com).

In instances where a payment cardholder is purchasing a travel-related service from a vendor, such as plane, train, bus, or other travel tickets, hotels, rental-cars and the like, the payment card transaction information contains addenda describing the purchase. For example, suppose the payment cardholder is purchasing plane tickets from New York City to San Francisco, Calif. The addenda can include itinerary information such as dates of travel, the airline and flight number, and origination/destination airport codes for the flights. This itinerary information can alternatively be sourced from a Global Distribution System or other travel data provider. As understood in the art, a Global Distribution System is generally a network that enables transactions between travel service providers (e.g., airlines, train operators, rental car companies) and travel reservation agents in order to provision travel-related services to end users.

In yet another embodiment, data warehouse 200 has one or more databases that store, review, and/or analyze information used in constructing: (i) the one or more associations between the payment card transaction information, the vendor information and the external information; (ii) the travel itineraries for the one or more entities based on the one or more associations; (iii) the events causing a change of travel itineraries; (iv) the services that help reduce negative consequences associated with the events; and (v) the entity-selectable options offering to provide the services.

In still another embodiment, data warehouse 200 has one or more databases that store, review, and/or analyze information used in creating one or more datasets to store: (i) the first set of information, the second set of information, and the third set of information; (ii) the planned travel information of the one or more entities; (iii) the information relating to the one or more associations between the payment card transaction information, the vendor information and the external information; (iv) the event information that indicates a change of current travel information; (v) the service information that helps reduce a negative consequence associated with the event; and (vi) the information relating to entity-selectable options offering to provide the service.

In another embodiment, data warehouse 200 stores, reviews, and/or analyzes information used in developing logic for creating (i) the one or more associations between the payment card transaction information, the vendor information and the external information; (ii) the travel itineraries for one or more entities based on the one or more associations; and (iii) the entity-selectable options offering to provide the services.

In another embodiment, data warehouse 200 stores, reviews, and/or analyzes information, with respect to the one or more associations amongst the payment card transaction information, the vendor information and the external information, used in assigning attributes to the one or more associations amongst the payment card transaction information, the vendor information, and the external information, in which the attributes are selected from the group consisting of one or more of confidence, time, and frequency.

In another embodiment, data warehouse 200 aggregates the information by payment cardholder, vendor, category and/or location. In still another embodiment, data warehouse 200 integrates data from one or more disparate sources. Data warehouse 200 stores current as well as historical data and is used for creating reports, performing analyses on the network, vendor analyses, and performing travel-related analyses. Other data sources can include, for example, weather, crew scheduling data, real-time aircraft maintenance data feeds, and the like.

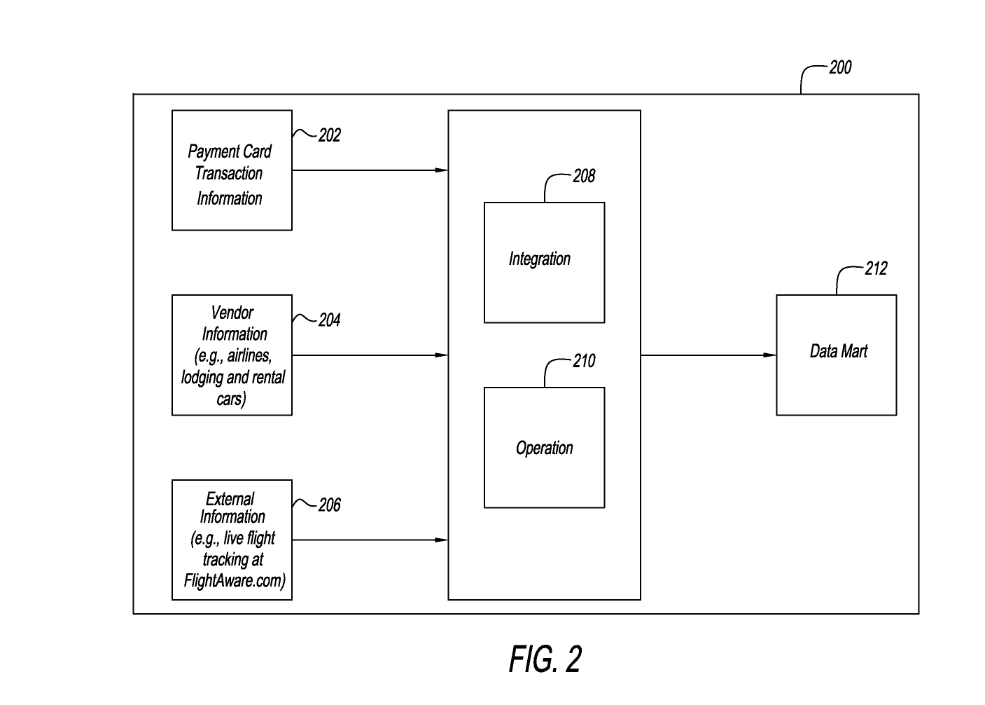

Referring to FIG. 2, an exemplary data warehouse 200 (the same data warehouse 200 in FIG. 1) for reporting and data analysis, including the storing, reviewing, and/or analyzing of information, for the various purposes described above is shown. The data warehouse 200 can have a plurality of entries (e.g., entries 202, 204 and 206).

The payment card transaction information 202 can include, for example, payment cardholder information, and purchasing and payment activities attributable to payment cardholders, that can be aggregated by payment cardholder, vendor, category (e.g., airlines, lodging, rental cars, etc.) and/or location in the data warehouse 200. The payment card transaction information 202 can also include, for example, a transaction identifier, geolocation of payment card transaction, geolocation date on which payment card transaction occurred, geolocation time on which payment card transaction occurred, payment card number, and the like.

The vendor information 204 can include, for example, a vendor name or identifier, geolocation of vendor, vendor category (e.g., airlines, lodging, rental cars, and the like), and the like.

The external information 206 includes, for example, travel information, such as live flight tracking information at FlightAware.com. The external information 206 can include other suitable information that can be useful in identifying: (i) the one or more associations between the payment card transaction information, the vendor information and the external information; (ii) the travel itineraries for the one or more entities based on the one or more associations; (iii) the events causing a change of travel itineraries; (iv) the services that help reduce negative consequences associated with the events; and (v) the entity-selectable options offering to provide the services.

The typical data warehouse uses staging, data integration, and access layers to house its key functions. The staging layer or staging database stores raw data extracted from each of the disparate source data systems. The integration layer integrates at 208 the disparate data sets by transforming the data from the staging layer often storing this transformed data in an operational data store database 210. For example, the payment card transaction information 202 can be aggregated by vendor, category and/or location at 208. Also, the reporting and data analysis, including the storing, reviewing, and/or analyzing of information, for the various purposes described above, can occur in data warehouse 200. The integrated data is then moved to yet another database, often called the data warehouse database or data mart 212, where the data is arranged into hierarchical groups often called dimensions and into facts and aggregate facts. The access layer helps users retrieve data.

A data warehouse constructed from an integrated data source system does not require staging databases or operational data store databases. The integrated data source systems can be considered to be a part of a distributed operational data store layer. Data federation methods or data virtualization methods can be used to access the distributed integrated source data systems to consolidate and aggregate data directly into the data warehouse database tables. The integrated source data systems and the data warehouse are all integrated since there is no transformation of dimensional or reference data. This integrated data warehouse architecture supports the drill down from the aggregate data of the data warehouse to the transactional data of the integrated source data systems.

The data mart 212 is a small data warehouse focused on a specific area of interest. For example, the data mart 212 can be focused on one or more of reporting and data analysis, including the storing, reviewing, and/or analyzing of information, for any of the various purposes described above. A data warehouse can be subdivided into data marts for improved performance and ease of use within that area. Alternatively, an organization can create one or more data marts as first steps towards a larger and more complex enterprise data warehouse.

This definition of the data warehouse focuses on data storage. The main source of the data is cleaned, transformed, cataloged and made available for use by managers and other business professionals for data mining, online analytical processing, market research and decision support. However, the means to retrieve and analyze data, to extract, filter, transform and load data, and to manage the data dictionary are also considered essential components of a data warehousing system. Many references to data warehousing use this broader context. Thus, an expanded definition for data warehousing includes business intelligence tools, tools to extract, filter, transform and load data into the repository, and tools to manage and retrieve metadata.

Algorithms can be employed to determine formulaic descriptions of the integration of the data source information using any of a variety of known mathematical techniques. These formulas, in turn, can be used to derive or generate one or more analyses and updates for analyzing, creating, comparing and identifying activities using any of a variety of available trend analysis algorithms. For example, these formulas can be used in the reporting and data analysis, including the storing, reviewing, and/or analyzing of information, for the various purposes described above.

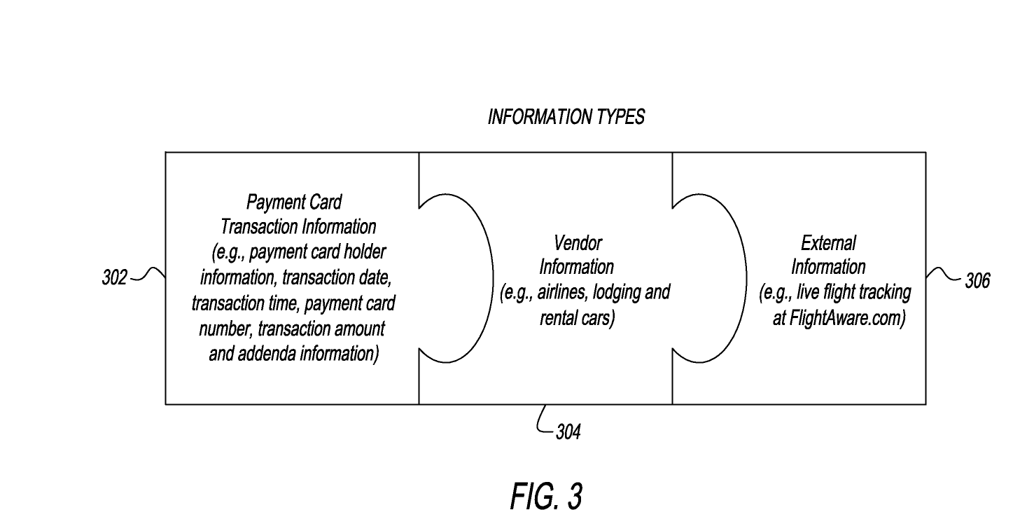

In accordance with the method of this disclosure, information that is stored in one or more databases can be retrieved (e.g., by a processor). FIG. 3 shows illustrative information types used in the systems and methods of this disclosure.

The information has, for example, a first set of information 302 that can be retrieved from one or more databases owned or controlled by an entity, for example, a payment card company (part of the payment card company network 150 in FIG. 1). The payment card transaction information 302 can include, for example, payment card transaction information, payment cardholder information (e.g., payment cardholder account identifier (likely anonymized), payment cardholder geography (potentially modeled), payment cardholder type (consumer/business), payment cardholder demographics, and the like), and purchasing and payment activities attributable to payment cardholders, that can be aggregated by payment cardholder, vendor and/or location, transaction date and time, and transaction amount. The transaction payment card information 302 can also include, for example, a transaction identifier, geolocation of payment card transaction, geolocation date on which payment card transaction occurred, geolocation time on which payment card transaction occurred, payment card number, and the like. Information for inclusion in the first set of information can be obtained, for example, from payment card companies known as MasterCard®, Visa®, American Express®, and the like (part of the payment card company network 150 in FIG. 1).

The transaction payment card information 302 can also include, for example, addenda information. The addenda can include itinerary information such as dates of travel, the airline and flight number, and origination/destination airport codes for the flights. This itinerary information can alternatively be sourced from a Global Distribution System or other travel data provider.

The vendor information 304 can include, for example, vendor name, vendor geography, vendor line of business, vendor category (e.g., airlines, lodging, rental cars, and the like), and the like. The vendor information 304 can also include, for example, a vendor identifier, geolocation of vendor, and the like.

The third set of information 306 can include, for example, travel information such as live flight tracking at FlightAward.com, and the like. The third set of information affords leveraged data sources that can supplement information in the first set of information and the second set of information.

With regard to the sets of information, one or more filters can be employed to select particular portions of the information. For example, time range filters can be used that can vary based on need or availability.

In an embodiment, all information stored in each of the one or more databases can be retrieved. In another embodiment, only a single entry in each database can be retrieved. The retrieval of information can be performed a single time, or can be performed multiple times. In an exemplary embodiment, only information pertaining to a specific entry is retrieved from each of the databases.

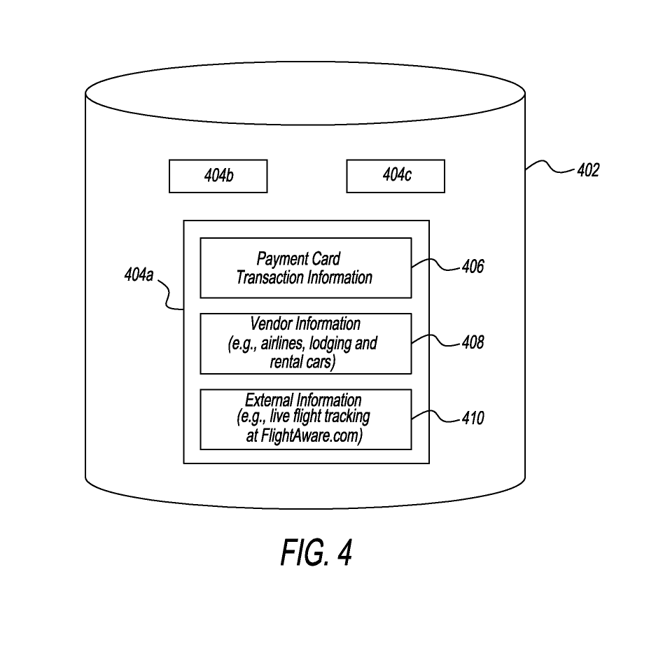

Referring to FIG. 4, an exemplary dataset 402 stores, reviews, and/or analyzes of information used in the systems and methods of this disclosure. The dataset 402 can include a plurality of entries (e.g., entries 404a, 404b, and 404c).

The payment card transaction information 406 includes payment card transactions and actual spending by payment cardholders. More specifically, payment card transaction information 406 can include, for example, payment card transaction information, transaction date and time, transaction amount, payment cardholder information (e.g., payment cardholder account identifier (likely anonymized), payment cardholder geography (potentially modeled), payment cardholder type (consumer/business), payment cardholder demographics, and the like), and purchasing and payment activities attributable to payment cardholders, that can be aggregated by payment cardholder, vendor and/or location, transaction date and time, and transaction amount. The transaction payment card information 406 can also include, for example, a transaction identifier, geolocation of payment card transaction, geolocation date on which payment card transaction occurred, geolocation time on which payment card transaction occurred, payment card number, and the like. Information for inclusion in the first set of information can be obtained, for example, from payment card companies known as MasterCard®, Visa®, American Express®, and the like (part of the payment card company network 150 in FIG. 1).

The transaction payment card information 406 can also include, for example, addenda information. The addenda can include itinerary information such as dates of travel, the airline and flight number, and origination/destination airport codes for the flights. This itinerary information can alternatively be sourced from a Global Distribution System or other travel data provider.

The vendor information 408 can include, for example, vendor name, vendor geography, vendor line of business, vendor category (e.g., airlines, lodging, rental cars, and the like), and the like. The vendor information 408 can also include, for example, a vendor identifier, geolocation of vendor, and the like.

The external information 410 includes, for example, include, for example, travel information such as live flight tracking at FlightAward.corn, and the like. The third set of information affords leveraged data sources that can supplement information in the first set of information and the second set of information. External information 410 includes other suitable information that can be useful in conducting the systems and methods of this disclosure.

Algorithms can be employed to determine formulaic descriptions of the integration of the payment card transaction information 406, vendor information 408 and the external information 410 using any of a variety of known mathematical techniques. These formulas, in turn, can be used to derive or generate one or more analyses and updates using any of a variety of available trend analysis algorithms. For example, these formulas can be used to construct the one or more associations between the payment card transaction information, the vendor information and the external information; the travel itineraries for the one or more entities based on the one or more associations; the events causing a change of travel itineraries; the services that help reduce negative consequences associated with the events; and the entity-selectable options offering to provide the services.

In an embodiment, logic is developed for deriving the one or more associations between the payment card transaction information, the vendor information and the external information; creating the proposed travel itineraries for one or more entities based on the one or more associations; and creating the entity-selectable options offering to provide the services.

In accordance with the method of this disclosure, information that is stored in one or more databases can be retrieved (e.g., by a processor). The information can include, for example, billing activities attributable to the financial transaction processing entity (e.g., a payment card company) and purchasing and payment activities, including date and time, attributable to payment cardholders, vendor information, travel information including live flight tracking information at FlightAware.com, and the like.

In an embodiment, all information stored in each database can be retrieved. In another embodiment, only a single entry in each of the one or more databases can be retrieved. The retrieval of information can be performed a single time, or can be performed multiple times. In an exemplary embodiment, only information pertaining to a specific travel itinerary is retrieved from each of the databases.

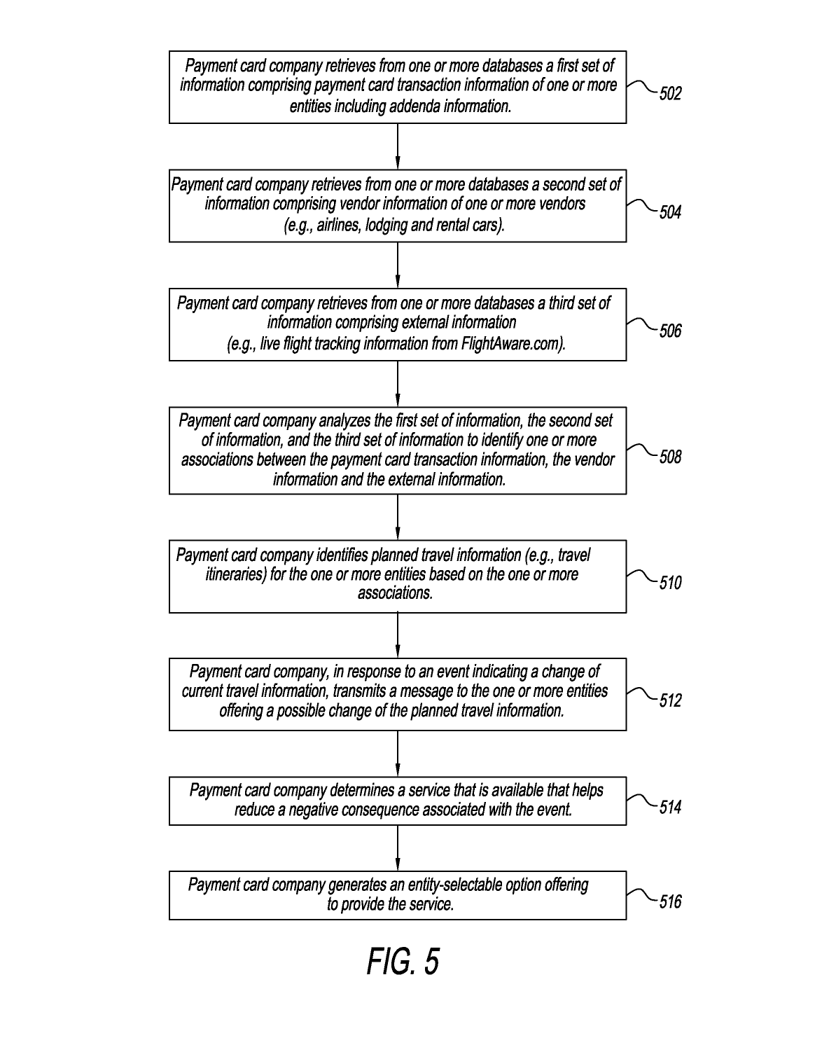

Referring to FIG. 5, the method of this disclosure involves a payment card company (part of the payment card company network 150 in FIG. 1) retrieving from one or more databases a first set of information comprising payment card transaction information of one or more entities (e.g., one or more payment cardholders). In particular, the information at 502 can include, for example, transaction date/time, transaction amount, payment cardholder information (e.g., payment cardholder account identifier (likely anonymized), payment cardholder geography (potentially modeled), payment cardholder type (consumer/business), and payment cardholder demographics (e.g., gender and age), and the like).

The transaction payment card information 502 can also include, for example, addenda information. The addenda can include itinerary information such as dates of travel, the airline and flight number, and origination/destination airport codes for the flights. This itinerary information can alternatively be sourced from a Global Distribution System or other travel data provider.

The method of this disclosure also includes the payment card company, namely its data warehouse, retrieving from one or more databases a second set of information comprising vendor information of one or more vendors. In particular, the information at 504 can include, for example, vendor information such as vendor name, vendor geography, vendor line of business, vendor category (e.g., airlines, lodging and rental cars), and the like.

The method of this disclosure also includes the payment card company retrieving from one or more databases a third set of information comprising external information. In particular, the information at 506 can include, for example, travel information such as live flight tracking at FlightAward.com, and the like. The third set of information affords leveraged data sources that can supplement information in the first set of information and the second set of information.

At 508, the payment card company analyzes the first set of information, the second set of information, and the third set of information to identify one or more associations amongst the payment card transaction information, the vendor information and the external information. At 510, the payment card company identifies planned travel information (e.g., travel itineraries) based on the one or more associations. At 512, the payment card company, in response to an event indicating a change of current travel information, transmits a message to the one or more entities offering a possible change of the planned travel information.

In one embodiment, at 514, the payment card company determines a service that is available that helps reduce a negative consequence associated with the event. At 516, the payment card company generates an entity-selectable option offering to provide the service.

As indicated above, the entity-selectable option is generated offering to provide the service. For example, if an entity has a meeting that runs late and causes the entity to miss a flight, a message (e.g., e-mail, text message, phone call or internet) can notify the entity that a flight has been missed and offer to book new travel arrangements (such as, e.g., a new airline ticket, hotel reservations, car rental, and the like), modify existing travel arrangements (e.g., reschedule a subsequent meeting, calculate a new time of arrival based on a later train or bus and update the travel itinerary, and the like), cancel existing travel arrangements, among other things.

In an embodiment, the entity (e.g., payment cardholder) provides feedback to the payment card company to enable the payment card company to monitor and track impact of the provided services by date and time. This “closed loop” system allows a payment card company to measure efficiency of the provided services, and make any improvements for the next selection.

One or more algorithms can be employed to determine formulaic descriptions of the assembly of the payment card transaction information, vendor information, and external information, using any of a variety of known mathematical techniques. These formulas, in turn, can be used to derive or construct the one or more associations between the payment card transaction information, the vendor information and the external information; the travel itineraries for the one or more entities based on the one or more associations; the events causing a change of travel itineraries; the services that help reduce negative consequences associated with the events; and the entity-selectable options offering to provide the services, using any of a variety of available trend analysis algorithms.

As indicated herein, the systems and the methods of this disclosure utilize standard statistical techniques (e.g., clustering, regression, correlation, segmentation, raking, and the like) to identify one or more associations amongst the payment card transaction information, the vendor information and the external information. The associations and relationships can be refined by looking at factors such as time, logical geographic breaks, frequency, and the like.

Logic can be developed for creating the one or more associations between the payment card transaction information, the vendor information and the external information; the travel itineraries for one or more entities based on the one or more associations; and the entity-selectable options offering to provide the services. Attributes (e.g., confidence, time, frequency, and the like) can then be assigned to clusters and/or members of the clusters to make the data useful to potential end users.

It will be understood that the present disclosure can be embodied in a computer readable non-transitory storage medium storing instructions of a computer program that when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A computer-implemented method for travel support services, the method comprising:
retrieving from one or more first databases a first set of information comprising payment card transaction information of one or more entities including addenda information;
retrieving from one or more second databases a second set of information comprising vendor information of one or more vendors;
retrieving from one or more third databases a third set of information comprising external information;
analyzing the first set of information, the second set of information, and the third set of information and filtering same to identify one or more associations between the payment card transaction information, the vendor information and the external information;
identifying planned travel information for the one or more entities based on the one or more associations; and
transmitting a message to the one or more entities offering a possible change of the planned travel information in response to an event indicating a change of current travel information.

2. The method of claim 1, wherein the planned travel information for the one or more entities comprises one or more travel itineraries for the one or more entities.

3. The method of claim 1, further comprising:
extracting planned travel information from payment addenda information.

4. The method of claim 1, further comprising:
determining a service that is available, wherein the service helps reduce a negative consequence associated with the event; and
generating an entity-selectable option offering to provide the service.

5. The method of claim 4, further comprising:
receiving an indication of an entity's desire to select the option; and
assisting in enabling the utilization of the service in response to receiving the indication.

6. The method of claim 5, wherein the service comprises at least one of implementing or facilitating the booking of new travel arrangements, implementing or facilitating the booking of a new airline ticket, implementing or facilitating the booking of new hotel reservations, implementing or facilitating a cancellation of existing travel arrangements, or implementing or facilitating a modification of existing travel arrangements.

7. The method of claim 5, wherein the assisting further comprises:
generating a message including information related to the event; and
sending the message to a device of the one or more entities.

8. The method of claim 1, wherein the payment card transaction information comprises at least date of payment card transaction, time of payment card transaction, and payment card number, wherein the vendor information comprises at least vendor name, and wherein the external information comprises at least travel tracking information.

9. The method of claim 1, further comprising:
algorithmically analyzing the first set of information, the second set of information, and the third set of information to identify one or more associations between the payment card transaction information, the vendor information and the external information.

10. The method of claim 1, further comprising:
algorithmically identifying planned travel information for the one or more entities based on the one or more associations.

11. The method of claim 1, further comprising:
determining a service that is available, wherein the service helps reduce a negative consequence associated with the event; and
algorithmically generating an entity-selectable option offering to provide the service.

12. The method of claim 1, further comprising creating one or more datasets to store information relating to the first set of information, the second set of information, and the third set of information; the planned travel information of the one or more entities; the information relating to the one or more associations between the payment card transaction information, the vendor information and the external information; the event information that indicates a change of the current travel information; the service information that helps reduce a negative consequence associated with the event; and the entity-selectable options offering to provide the service.

13. The method of claim 1, further comprising creating one or more datasets to store information relating to implementing or facilitating the booking of new travel arrangements, implementing or facilitating the booking of a new airline ticket, implementing or facilitating the booking of new hotel reservations, implementing or facilitating a cancellation of existing travel arrangements, and/or implementing or facilitating a modification of existing travel arrangements.

14. The method of claim 1, further comprising developing logic for creating the one or more associations between the payment card transaction information, the vendor information and the external information; the travel itineraries for one or more entities based on the one or more associations; and the entity-selectable options offering to provide the services.

15. The method of claim 1, further comprising: determining a current time, wherein the event is also based on the current time.

16. A system comprising:
one or more databases configured to store a first set of information comprising payment card transaction information of one or more entities including addenda information;
one or more databases configured to store a second set of information comprising vendor information of one or more vendors;
one or more databases configured to store a third set of information comprising external information;
a processor configured to:
analyze the first set of information, the second set of information, and the third set of information to identify one or more associations between the payment card transaction information, the vendor information and the external information;
identify planned travel information for the one or more entities based on the one or more associations; and
in response to an event indicating a change of current travel information, transmit a message to the one or more entities offering a possible change of the planned travel information.

17. The system of claim 16, wherein the planned travel information for the one or more entities comprises one or more travel itineraries for the one or more entities.

18. The system of claim 16, wherein the processor is configured to:
determine a service that is available, wherein the service helps reduce a negative consequence associated with the event;
generate an entity-selectable option offering to provide the service;
receive an indication of an entity's desire to select the option; and
assist in enabling the utilization of the service in response to receiving the indication.

19. The system of claim 16, wherein the service comprises at least one of implementing or facilitating the booking of new travel arrangements, implementing or facilitating the booking of a new airline ticket, implementing or facilitating the booking of new hotel reservations, implementing or facilitating a cancellation of existing travel arrangements, or implementing or facilitating a modification of existing travel arrangements.

20. The system of claim 16, wherein the processor is configured to:
generate a message including information related to the event; and
send the message to a device of the one or more entities.

21. The system of claim 16, wherein the one or more entities are payment cardholders, and wherein transmitting a message to the one or more entities is carried out by e-mails, text messages, phone calls or internet.

22. The system of claim 16, wherein the payment card transaction information comprises at least date of payment card transaction, time of payment card transaction, and payment card number, wherein the vendor information comprises at least vendor name, and wherein the external information comprises at least travel tracking information.

23. The system of claim 16, wherein the processor is configured to:
algorithmically analyze the first set of information, the second set of information, and the third set of information to identify one or more associations between the payment card transaction information, the vendor information and the external information;
determine a service that is available, wherein the service helps reduce a negative consequence associated with the event; and
algorithmically generate an entity-selectable option offering to provide the service.
